(19) United States
(12) Patent Application Publication
(10) Pub. No.: US 2013/0115497 A1
(43) Pub. Date: May 9, 2013

(54) BUS BATTERY CONVERSION AND HOLD DOWN KIT

(71) Applicant: Thermo King Corporation, Minneapolis, MN (US)

(72) Inventor: Christopher D. Ertel, Minneapolis, MN (US)

(73) Assignee: THERMO KING CORPORATION, Minneapolis, MN (US)

(21) Appl. No.: 13/650,960

(22) Filed: Oct. 12, 2012

Related U.S. Application Data
(60) Provisional application No. 61/555,055, filed on Nov. 3, 2011.

(51) Int. Cl. H01M 2/10; H01M 6/02

(52) U.S. Cl. 429/99; 429/100; 429/96; 29/623.1

(57) ABSTRACT

A bus battery tray assembly for securing one or more bus batteries, in which each bus battery has two battery terminals, includes a battery tray for supporting the one or more batteries and a battery tray cover assembly. The battery tray cover assembly includes a plate having a bottom surface with a plurality of projections extending from the bottom surface. The plurality of projections are disposed to position the one or more bus batteries on the tray. The battery tray cover also includes a bracket coupled to the plate with a front face substantially orthogonal to the plate and a plurality of plate terminals located on the front face. The assembly further includes a plurality of battery cables, wherein each cable connects a battery terminal to a plate terminal.

### RELATED APPLICATION DATA

The present application claims priority under 35 U.S.C. §119 to Provisional Patent Application No. 61/555,055, filed Nov. 3, 2011, the disclosure of which is hereby incorporated by reference.

### BACKGROUND

The present invention relates to a hold down kit for aligning and retaining a plurality of batteries in a battery tray.

Many transit buses currently use relatively large “8D” style wet cell batteries for 12 VDC and 24 VDC power requirements. Such batteries may be located in the front, middle, or rear of the bus and are typically housed in a readily accessible compartment. Within the compartment, the batteries are positioned on a battery tray and connect to the bus battery cables. Due to the relatively short life of the 8D batteries, however, transit authorities continue to look for economical ways to replace the 8D batteries with smaller “G31” style absorbed glass mat (AGM) dry cell batteries, which have a longer life for the operational conditions encountered.

### SUMMARY

The conversion from larger 8D style wet cell batteries to G31 AGM dry cell batteries should be accomplished with as little disruption to the existing components as possible. For example, preserving readily accessible terminal connections not only maintains convenient operational features, such as easy jump starting, but allows for the reuse of existing bus battery cables. This keeps conversion costs low and minimizes the overall effort necessary for battery reconfiguration.

In one embodiment of a bus battery holder kit for securing one or more bus batteries to a battery tray, in which each bus battery has two battery terminals, the kit includes a first plate having a bottom surface and including a plurality of projections extending from the bottom surface. The plurality of projections are disposed to position the one or more bus batteries on the tray. A second plate is positioned substantially orthogonal to the first plate and includes a front face and a plurality of plate terminals. The kit further includes a plurality of battery cables, wherein each cable connects a battery terminal to a plate terminal.

In one embodiment of a bus battery tray assembly for securing one or more bus batteries, in which each bus battery has two battery terminals, the assembly includes a battery tray for supporting the one or more batteries and a battery tray cover assembly. The battery tray cover assembly includes a plate having a bottom surface with a plurality of projections extending from the bottom surface. The plurality of projections are disposed to position the one or more bus batteries on the tray. The battery tray cover also includes a bracket coupled to the plate with a front face substantially orthogonal to the plate and a plurality of plate terminals located on the front face. The assembly further includes a plurality of battery cables, wherein each cable connects a battery terminal to a plate terminal.

In one embodiment of a bus battery holder kit for securing one or more G31 style bus batteries to a battery tray, in which each bus battery has two battery terminals and a handle recess, the kit includes a first plate having a bottom surface and a top surface and including a plurality of spacers and a plurality of protrusions extending from the bottom surface. The plurality of spacers align the one or more bus batteries on the tray and each protrusion concurrently fits within a handle recess to uniquely orient the one or more bus batteries on the tray. The first plate further includes a plurality of apertures, wherein the battery terminals of at least one of the one or more batteries each extend through an aperture. A second plate is coupled to the first plate and positioned substantially orthogonal to the first plate and includes a front face and a plurality of plate terminals located on the front face. The kit further includes a plurality of battery cables, wherein each cable connects a battery terminal to a plate terminal and is routed at least partially across the top surface.

In one embodiment of a method of retrofitting a bus battery system, in which the bus battery system has an accessible front side and includes an existing bus battery tray and an existing bus battery cable, the method includes removing a plurality of first bus batteries having a first size from the bus battery tray and disposing a plurality of second bus batteries having a second size on the bus battery tray in a first configuration, each second bus battery having two battery terminals and a handle recess. The method also includes positioning a cover plate having a bottom surface and a top surface and including a plurality of apertures and a plurality of spacers and protrusions extending from the bottom surface, over the first configuration. The cover plate further includes a terminal bracket having first, second, and third connection terminals at the front side. The method further includes aligning the plurality of apertures over the bus battery terminals, separating adjacent ones of the second bus batteries with the spacers, and fitting each protrusion within a handle recess. The method additionally includes electrically coupling a connection cable between at least one battery terminal and one of the first, second, and third connection terminals, the connection cable extending at least partially across the top surface. The method also includes coupling the bus battery cable to the one of the first, second, and third connection terminals.

Other aspects of the invention will become apparent by consideration of the detailed description and accompanying drawings.

### BRIEF DESCRIPTION OF THE DRAWINGS

FIG. 1 is a perspective view of a bus showing the relative location of the battery compartment.

FIG. 2 is a perspective view of a battery retaining system within the compartment of FIG. 1.

FIG. 3 is an exploded view of the battery retaining system of FIG. 2.

FIG. 4 is a top view of the battery retaining system of FIG. 2.

FIG. 5 is an underside perspective view of the top and front plate of the battery holder kit that forms part of the battery retaining system of FIG. 2.

FIG. 6 is an exploded view of the top plate of FIG. 5.

FIG. 7 is a top view of the top and front plate of FIG. 5 showing the position of the battery spacers and handle protrusions mounted on the underside of the top plate.

FIG. 8 is a top view of the batteries positioned on the battery tray showing the spacers and handle protrusions without the top plate.

FIG. 9 is a partial cross sectional perspective taken along line 9-9 of FIG. 7.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. And as used herein and in the appended claims, the terms “upper”, “lower”, “top”, “bottom”, “front”, “back”, and other directional terms are not intended to require any particular orientation, but are instead used for purposes of description only.

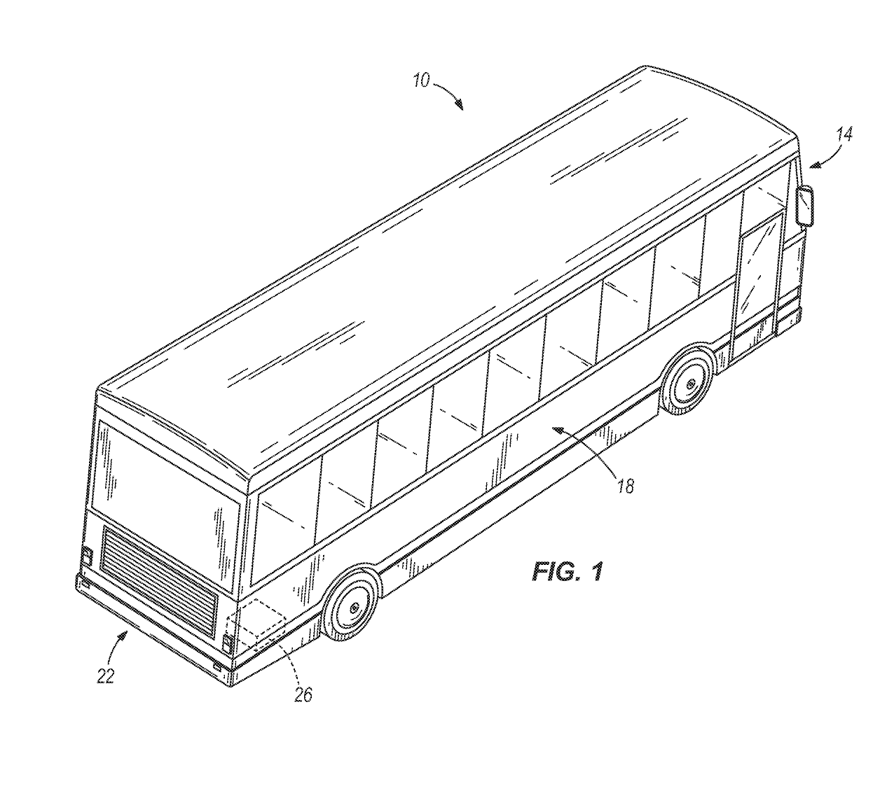

FIG. 1 illustrates a conventional transit bus 10 having a front portion 14 in which a bus driver operates, a middle passenger compartment 18, and a rear portion 22 containing the bus engine and, as shown, a battery compartment 26 housing a battery retaining system.

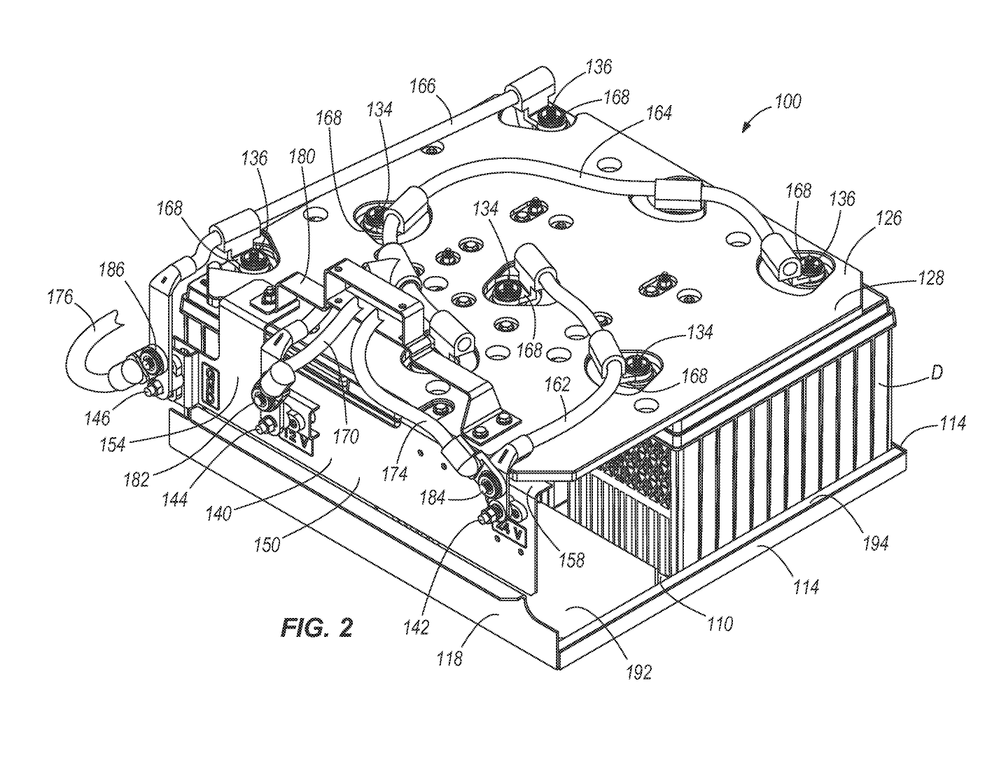

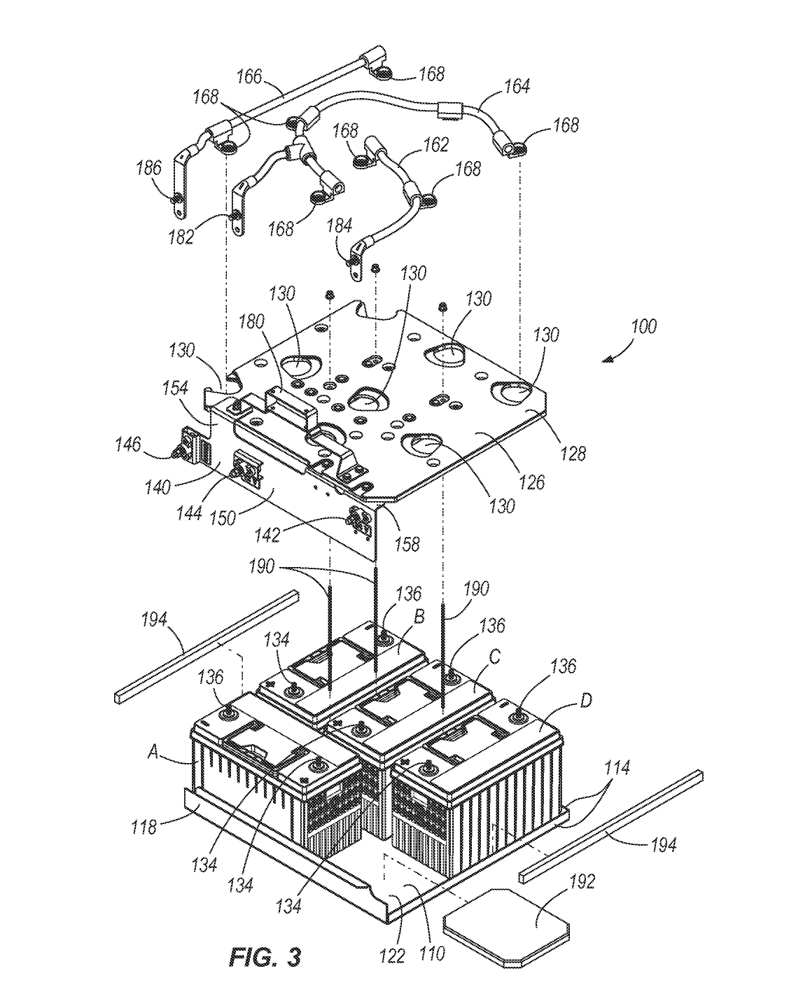

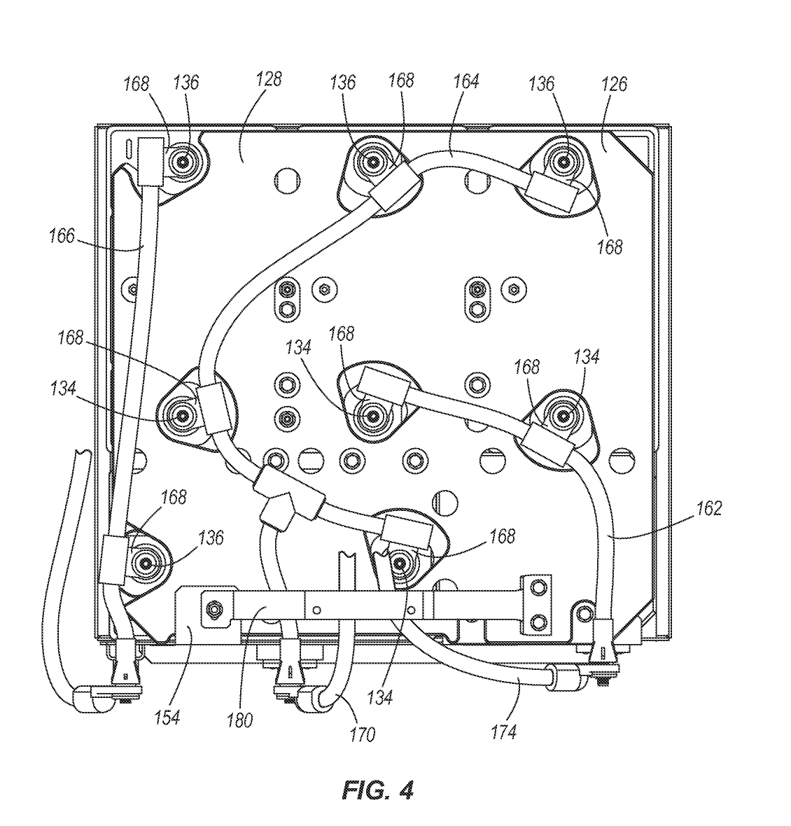

Referring to FIGS. 2-4, the battery retaining system 100 includes a battery tray 110 supporting four batteries A, B, C, D. The battery tray 110 includes peripheral edges 114 (one of which is not shown) and a front edge 118 at an accessible front side to assist in containing the batteries on the battery tray surface 122. In the construction shown, four 12 volt batteries, A, B, C, D, are shown positioned on the battery tray surface 122, however, any number of batteries may be used. The batteries may be G31 AGM dry cell batteries, but the exact battery type is not limiting and the features hereby described can be modified as necessary to support additional battery types. A solid top or cover plate 126 having a top surface 128 overlies the batteries and is sized in plan view to generally correspond to the size of the battery tray 110. The top plate 126 is constructed from plastic or metal, although additional suitable materials can also be used. The top plate 126 includes terminal apertures 130 (FIG. 3) coinciding with the battery terminals 134 (positive), 136 (negative) of batteries, A, B, C, D, and through which the battery terminals 134, 136 project.

A terminal bracket, or front plate 140, substantially orthogonal to the top plate 126 includes 24 VDC, 12 VDC, and Ground connection terminals 142, 144, 146. The terminals 142, 144, 146 can be located where convenient on the front face 150 of the front plate 140 and, for example, the 12 VDC and 24 VDC connections 144, 142 can be adjacent each other or at opposite sides of the front plate 140 to accommodate the existing bus cables. The front plate 140 is coupled to the top plate 126 and includes a bracket arm 154 initially extending parallel to the front face 150 adjacent the Ground connection 146. The bracket arm 154 includes an approximate ninety degree bend for removably securing the front plate 140 to the top plate 126 using conventional hardware. An additional second bend 158 of the front plate 140 adjacent the illustrated 24 VDC terminal 142 also, in conjunction with the bracket arm 154, removably secures the front plate 140 to the top plate 126. The front plate 140 is preferably constructed of a metal such as aluminum.

A plurality of connecting cables 162, 164, 166 electrically couples the battery terminals 134, 136 to the front plate terminal connections 142, 144, 146. Each cable 162, 164, 166 includes a connector 168 for particular corresponding battery terminals 134, 136 and is routed over the top surface 128 of the top plate 126 to a respective terminal 142, 144, 146. For example, the Ground connecting cable 166 connects the negative terminals 136 of the batteries A, B to the Ground terminal 146 on the front plate 140. The 24 VDC connecting cable 162 connects the positive terminals 134 of the batteries C, D to the 24 VDC terminal 142 on the front plate 140. The 12 VDC cable 164 connects the positive terminals 134 of the batteries A, B and the negative terminals 136 of the batteries C, D to the 12 VDC terminal 144. Thus, a potential of 12V is available between the 12 VDC terminal 144 and the Ground terminal 146 from batteries A, B, and a potential of 24V is available between the 24 VDC terminal 142 and the Ground terminal 146 by virtue of the series connection from batteries A, B to batteries C, D, respectively.

The connections from the bus 10 to the front plate terminals 142, 144, 146 are made with a pair of bus cables 170, 174 that pass through a conduit (not shown) and extend through a bus cable bracket 180 on the top plate 126 adjacent the front plate 140. The bus cable bracket 180 is removably coupled to both the front plate 140 and the top plate 126, as illustrated. In some constructions, the bus cable bracket 180 is only coupled to the top plate 126. The bus cables 170, 174 are coupled to secondary connections 182, 184 on the 12 VDC cable 164 and the 24 VDC cable 162, respectively. A third bus cable 176, which can in some instances also pass through the conduit and the bus cable bracket 180, is coupled to a secondary connection 186 on the Ground cable 166. Some buses utilize means other than a conduit to convey the bus cables 170, 174, 176 to the terminals 142, 144, 146 and therefore a bus cable bracket 180 may not be present.

Tie-down rods, or studs 190, secure the batteries A, B, C, D between the battery tray surface 122 and the top plate 126. Due to the use of a solid top plate, only a minimum number of hold-down holes need to be drilled in the existing battery tray 110. A tray spacer plate 192 and a pair of tray spacer bars 194 assist in impeding motion of the batteries on the battery tray 110 during operation.

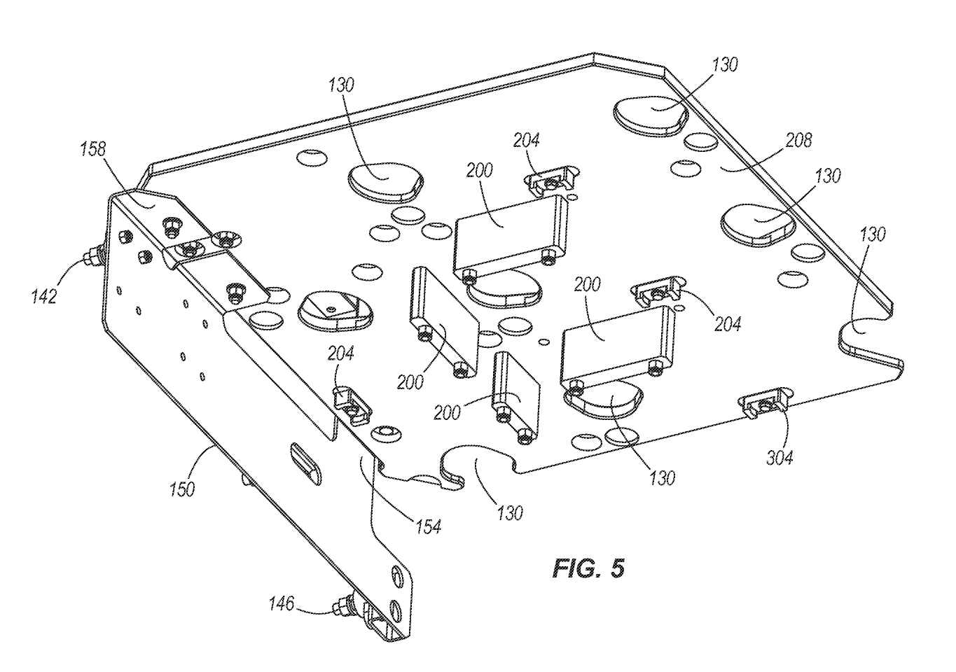

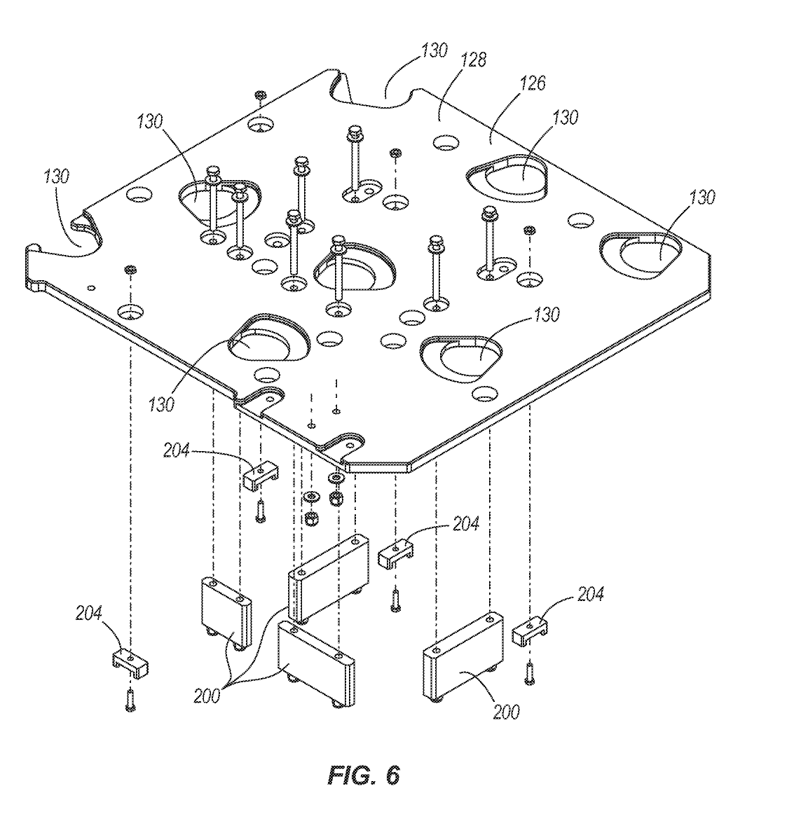

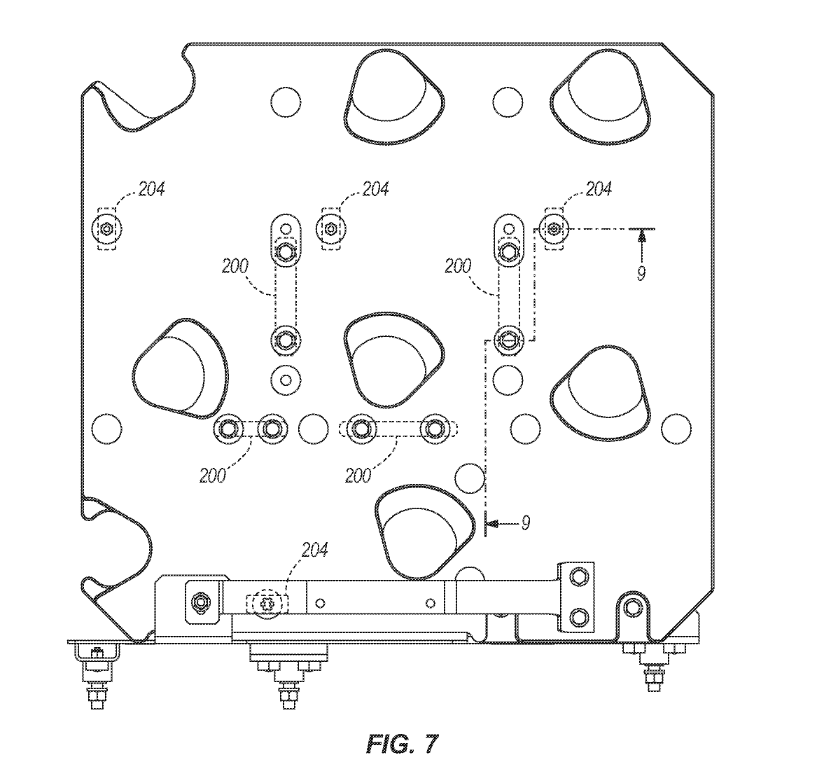

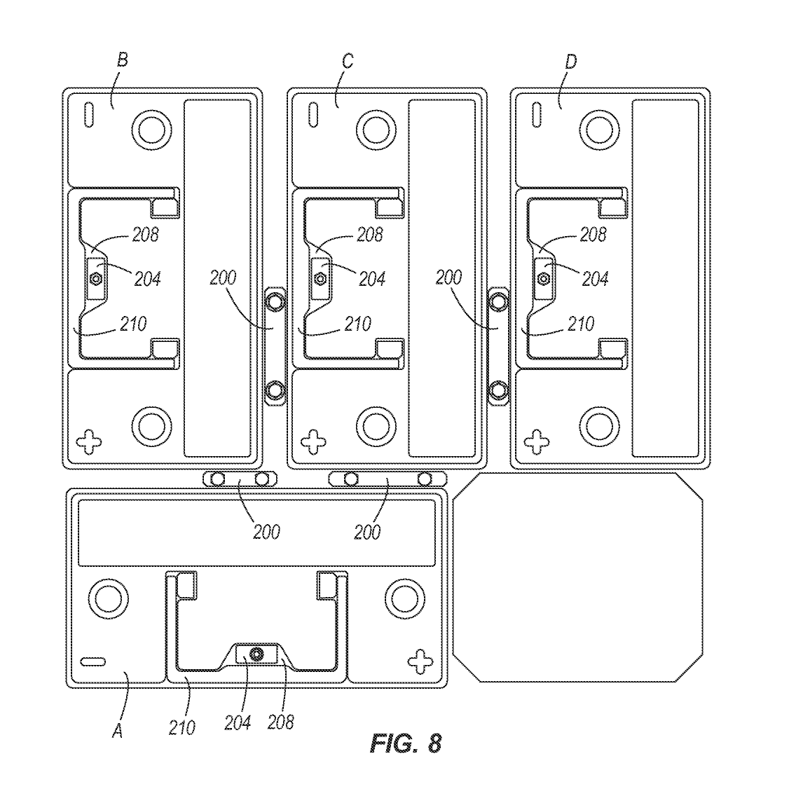

Referring to FIGS. 5 and 6, the underside of the top plate 126 reveals a plurality of battery spacers 200 and a plurality of handle protrusions 204 extending from the bottom surface 208 of the top plate 126. Each of the battery spacers 200 and handle protrusions 204 is constructed primarily from plastic and is removably coupled to the top plate 126 using conventional mounting hardware. The battery spacers 200 and handle protrusions 204 are positioned to correspond with the placement of the batteries A, B, C, D on the battery tray 110. Referring to FIGS. 5, 7, and 8, the battery spacers 200 extend from the top plate 126 between the edges of the batteries A, B, C, D and help align the batteries such that they are positioned or oriented as shown on the battery tray 110 in FIG. 8. Specifically, one battery spacer 200 is positioned between the batteries B, C and another is positioned between the batteries C, D. Two additional battery spacers 200 separate the battery A from the batteries B, C. The handle protrusions 204 extend within handle recesses 208 that are formed in each battery top to allow a user to grasp the handle 210 and transport the battery. The handle protrusions 204 additionally prevent a positioning or orientation of the batteries other than that which is illustrated in FIG. 8.

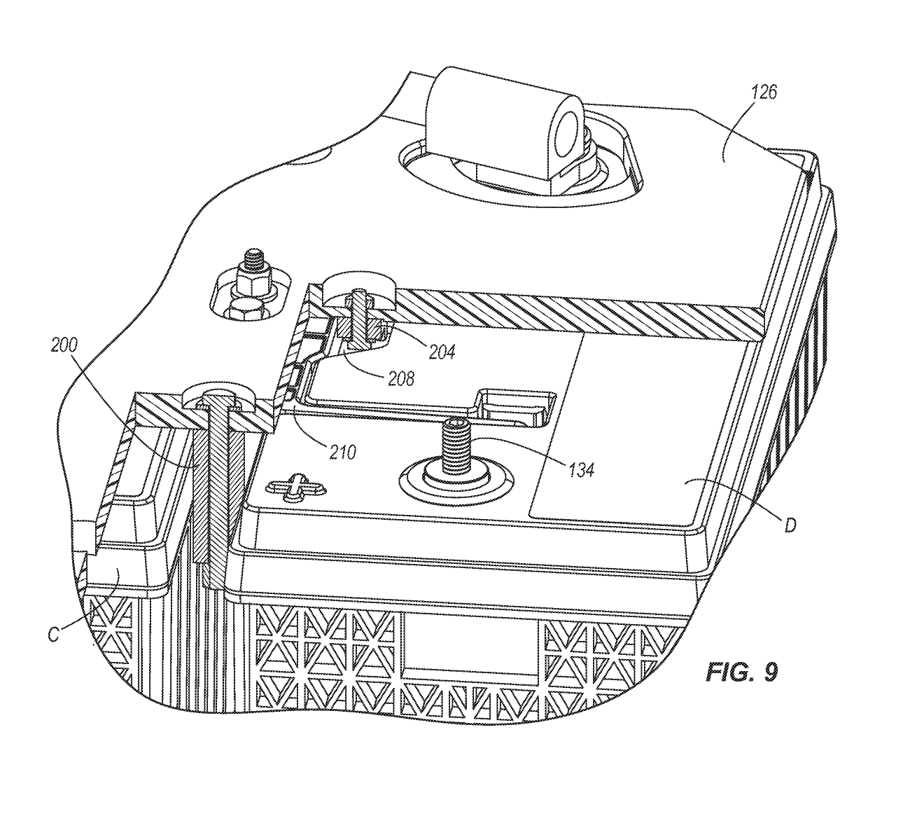

Referring to FIG. 9, the extension of a battery spacer 200 and of a handle protrusion 204 is shown in further detail. As illustrated, the battery spacer 200 fits within the space between two batteries (batteries C, D). Also illustrated is the handle protrusion 204 situated within the handle depression 204 of battery D.

In assembly, any existing batteries are removed from the battery tray 110 and replacement batteries are placed on the tray 110 in the position shown in FIG. 8. The top plate 126 is positioned over the batteries A, B, C, D, and the terminal apertures 130 are operationally aligned with the battery terminals 134, 136. Positioning the top plate on the battery terminals 134, 136 concurrently disposes a battery spacer 200 between the batteries B, C, and between the batteries C, D, respectively, and disposes two additional battery spacers 200 in the separation between the battery A and batteries B, C. Due to the fixed relationship between the battery spacers 200 and the handle protrusions 204, the handle protrusions 204 simultaneously individually fit within each of the handle recesses 208 of batteries A, B, C, D. The top plate 126 is secured to the battery tray 110 through the plurality of tie-down studs 190, retaining the batteries A, B, C, D in position on the battery tray 110 during bus operation. Thus, the four batteries A, B, C, D can only be installed in one orientation on the battery tray 110 if the top plate 126 is to be positioned and secured onto the batteries A, B, C, D. The connectors 168 of the connecting cables 162, 164, 166 are fastened to the individual battery terminals 134, 136 and the cables routed over the top plate 126 to the 24 VDC, 12 VDC, and Ground connections 142, 144, 146 at the front plate 140, as previously described. The current internal bus battery cables 170, 174, 176 are then electrically joined to each of the 24 VDC, 12 VDC, and Ground cables 162, 164, and 166 at the secondary connections 184, 182, 186, respectively.

Operationally, the bus can be jump started by attaching a cable from the positive terminal of a donor battery to any of the 12 VDC and 24 VDC terminals 142, 144, and from the negative terminal of the donor battery to the Ground terminal 146.

The reuse of some components of the existing battery retaining system, such as the current bus wiring, offers cost and labor savings and a consequently easier conversion from 8D style batteries to G31 style batteries. For example, reusing the current bus cables eliminates the need to replace and reroute cables through the bus. In addition, the configuration of the present invention does not change the current junction locations at the front of the bus battery compartment, allowing for relatively easy jump starting of the bus.

The embodiment previously described is not to be construed as limiting. In other constructions with, for example, differently sized batteries or with a different number of batteries, additional battery spacers or battery spacers specifically sized for the batteries may be employed to properly orient the batteries on the tray. Likewise, the handle protrusions can be modified as necessary for different battery handle configurations.

The invention is designed to retrofit an existing battery retaining system, in which a bus battery holder kit can comprise a cover assembly including the top and front plates, as substantially described, along with the connecting cables. In some applications the cover assembly, along with the battery cables and, for example, a battery tray can be used as an original equipment manufacturer (OEM) assembly.

Various features and advantages of the invention are set forth in the following claims.

1. A bus battery holder kit for securing one or more bus batteries to a battery tray, each bus battery having two battery terminals, the kit comprising:
a first plate having a bottom surface and including a plurality of projections extending from the bottom surface, the plurality of projections disposed to position the one or more bus batteries on the tray;
a second plate positioned substantially orthogonal to the first plate and including a front face and a plurality of plate terminals; and
a plurality of battery cables, wherein each cable connects a battery terminal to a plate terminal.

2. The bus battery holder kit of claim 1, wherein the second plate is coupled to the first plate.

3. The bus battery holder kit of claim 1, wherein the one or more bus batteries are G31 style batteries.

4. The bus battery holder kit of claim 3, wherein the G31 style batteries are absorbed glass mat (AGM) dry cell batteries.

5. The bus battery holder kit of claim 1, wherein the first plate further includes a plurality of apertures, wherein the battery terminals of at least one of the one or more batteries each extend through an aperture.

6. The bus battery holder kit of claim 1, wherein each projection is removably coupled to the first plate.

7. The bus battery holder kit of claim 1, wherein each bus battery includes a handle and a handle recess, and wherein the plurality of projections comprise a plurality of spacers and a plurality of protrusions, wherein the plurality of spacers align the one or more bus batteries on the tray and wherein each protrusion concurrently fits within a handle recess, whereby the one or more bus batteries are uniquely oriented on the tray.

8. The bus battery holder kit of claim 1, wherein each bus battery includes a handle and a handle recess, and wherein the plurality of projections include a plurality of protrusions, wherein each protrusion uniquely fits within a handle recess, whereby the one or more bus batteries are oriented in a particular configuration on the tray.

9. The bus battery holder kit of claim 1, wherein the first plate has a top surface and wherein each of the battery cables is routed at least partially across the top surface.

10. A bus battery tray assembly for securing one or more bus batteries, each bus battery having two battery terminals, the assembly comprising:
a battery tray for supporting the one or more batteries;
a battery tray cover assembly including
a plate having a bottom surface and including a plurality of projections extending from the bottom surface, the plurality of projections disposed to position the one or more bus batteries on the tray;
a bracket coupled to the plate and having a front face substantially orthogonal to the plate and a plurality of plate terminals located on the front face; and
a plurality of battery cables, wherein each cable connects a battery terminal to a plate terminal.

11. The assembly of claim 10, further including a battery cover stud coupling the plate to the battery tray.

12. The bus battery holder kit of claim 10, wherein the one or more bus batteries are G31 style batteries.

13. The bus battery holder kit of claim 10, wherein the plate further includes a plurality of apertures, and wherein each battery terminal of at least one of the one or more bus batteries extends through an aperture.

14. The bus battery holder kit of claim 10, wherein each projection extending from the bottom surface is removably coupled to the plate.

15. A bus battery holder kit for securing one or more G31 style bus batteries to a battery tray, each bus battery having two battery terminals and a handle recess, the kit comprising:
a first plate having a bottom surface and a top surface and including a plurality of spacers and a plurality of protrusions extending from the bottom surface, wherein the plurality of spacers align the one or more bus batteries on the tray and wherein each protrusion concurrently fits within a handle recess to uniquely orient the one or more bus batteries on the tray, the first plate further including a plurality of apertures, wherein the battery terminals of at least one of the one or more batteries each extend through an aperture;
a second plate coupled to the first plate and positioned substantially orthogonal to the first plate and including a front face and a plurality of plate terminals located on the front face; and
a plurality of battery cables, wherein each cable connects a battery terminal to a plate terminal and is routed at least partially across the top surface.

16. A method of retrofitting a bus battery system, the bus battery system having an accessible front side and including an existing bus battery tray and an existing bus battery cable, the method comprising:
removing a plurality of first bus batteries having a first size from the bus battery tray;
disposing a plurality of second bus batteries having a second size on the bus battery tray in a first configuration, each second bus battery having two battery terminals and a handle recess;
positioning a cover plate having a bottom surface and a top surface and including a plurality of apertures and a plurality of spacers and protrusions extending from the bottom surface, over the first configuration, the cover plate further including a terminal bracket having first, second, and third connection terminals at the front side;
aligning the plurality of apertures over the bus battery terminals, separating adjacent ones of the second bus batteries with the spacers, and fitting each protrusion within a handle recess;
electrically coupling a connection cable between at least one battery terminal and one of the first, second, and third connection terminals, the connection cable extending at least partially across the top surface; and
coupling the bus battery cable to the one of the first, second, and third connection terminals.
